(19) United States
(12) Patent Application Publication
(10) Pub. No.: US 2002/0182480 A1
(43) Pub. Date: Dec. 5, 2002

(54) Electrical energy storage pack

(76) Inventors: Brad T. Hanauer, Muncie, IN (US); Robert C. Beer, Noblesville, IN (US); John Eugene Waters, Fishers, IN (US)

Correspondence Address: MARGARET A. DOBROWITSKY DELPHI TECHNOLOGIES, INC., Legal Staff, P.O. Box 5052, Mail Code: 480-414-420, Troy, MI, 48007-5052, US

(21) Appl. No.: 09/873,816

(22) Filed: Jun. 4, 2001

(51) Int. Cl. H01M 10/50; H01M 2/24

(52) U.S. Cl. 429/62; 429/160

(57) ABSTRACT

A pack for batteries or other electrical storage devices, such as capacitors, is designed for ease of manufacture and installation of components in the case with vertical motions to provide an efficient and cost effective assembly. An exemplary embodiment has a molded case and cover in which all of the internal components are installed in the case through the open top without requiring fasteners, tools or additional supporting parts. The components include a flexible circuit on a flexible plastic sheet carrying control and sensor circuitry and temperature sensors together with internal and external connectors. Buss bars and connecting terminals mount in vertical slots and include prongs that extend through flexible flap connectors into guide recesses to provide connections to the flexible circuit. Batteries with vertical blade terminals are received in slots of the buss bars. An electronic control module and current sensor are also provided.

### TECHNICAL FIELD

This invention relates to electrical energy storage and supply packs, including packs of batteries, capacitors, including ultra capacitors, or other such electrical energy storage devices, primarily for use in vehicles. More particularly, the invention pertains to a pack in which multiple electrical storage devices such as batteries, buss bars and other components are mounted in a case through an open top using downward motions without the use of fasteners, tools or extra parts.

### BACKGROUND OF THE INVENTION

It is known in the art relating electrically powered vehicles, including hybrid vehicles, to provide a battery pack with a plurality of batteries connected to provide adequate power, energy and voltage for operating a vehicle. Such a pack may include a plurality of batteries or cells mounted in a case and connected in series to obtain the necessary voltage, energy and power. Additional components, such as buss bars or other connectors, control circuits, sensors, controllers and various supports and fasteners for mounting the components may also be provided.

### SUMMARY OF THE INVENTION

The present invention provides a battery pack, capacitor pack, or other electrical energy storage and supply pack, having a structural enclosure, such as a molded case and cover in which all of the internal components are installed in the case through the open top without requiring fasteners, tools or additional supporting parts. The case and components are configured for preferred installation of the components with generally vertical downward motion.

A flexible circuit on a flexible plastic sheet placed in the bottom of the case carries control and sensor circuitry and temperature sensors together with internal and external connectors. Buss bars with connected terminals mount in vertical slots on opposite sides of the case and include prongs that extend through flexible flap connectors into guide recesses to provide connections to the flexible circuit. Batteries with vertical blade terminals are received in slots of the buss bars. An electronic control module carried in wall slots is plugged into the internal connector for reading and controlling the batteries through the flexible circuit. A current sensor is mounted on one of the battery terminals. All these components are designed for ease of manufacture and installation in the case with vertical motions to provide efficient and cost effective manufacture and durability. The enclosure case and cover include ventilation openings for passing air to maintain suitable battery temperatures.

These and other features and advantages of the invention will be more fully understood from the following description of certain specific embodiments of the invention taken together with the accompanying drawings. The terms battery and batteries as used herein are intended to include other types of electrical storage devices which may be used in place of batteries in a pack of the type described. Capacitors, including ultra-capacitors, are examples of such devices.

### BRIEF DESCRIPTION OF THE DRAWINGS

In the drawings:

FIG. 1 is an exploded view of an exemplary embodiment of battery pack in accordance with the invention;

FIG. 2 is a pictorial view from a lower corner of the battery pack partially broken away to show the internal components;

FIG. 3 is a cross-sectional view from the line 3-3 of FIG. 2 showing the buss bar circuit connections;

FIG. 4 is a cross-sectional view from the line 4-4 of FIG. 2 showing the battery to thermal sensor interface; and

FIG. 5 is a cross-sectional view from the line 5-5 of FIG. 3 showing the buss bar mounting and battery interface.

### DESCRIPTION OF THE PREFERRED EMBODIMENT

Referring now to the drawings in detail, numeral 10 generally indicates an exemplary embodiment of a battery pack, or other electrical energy storage and supply pack, in accordance with the present invention. Battery pack 10 includes a structural enclosure 12 containing separately assembled components including a flexible circuit 14, positive and negative terminals 16, 18, buss bars 20, batteries (or capacitors) 22 and an electronic control module (ECM) 24.

Enclosure 12 includes a case 25 preferably molded of a material having substantial strength and electrical insulating characteristics. The case 25 has a generally rectangular bottom wall 26 connected at peripheral edges 28 with enclosing opposite side walls 30, 32 and opposite front and rear end walls 34, 36 extending to an open top 38. A preferably molded cover 40 is mounted on the walls and closes the open top. The cover may be secured to the case by suitable fasteners, not shown, or may be permanently attached as by adhesive material or otherwise. The bottom wall 26 and the cover 40 are provided with air openings 42 for passing cooling air through the case 25.

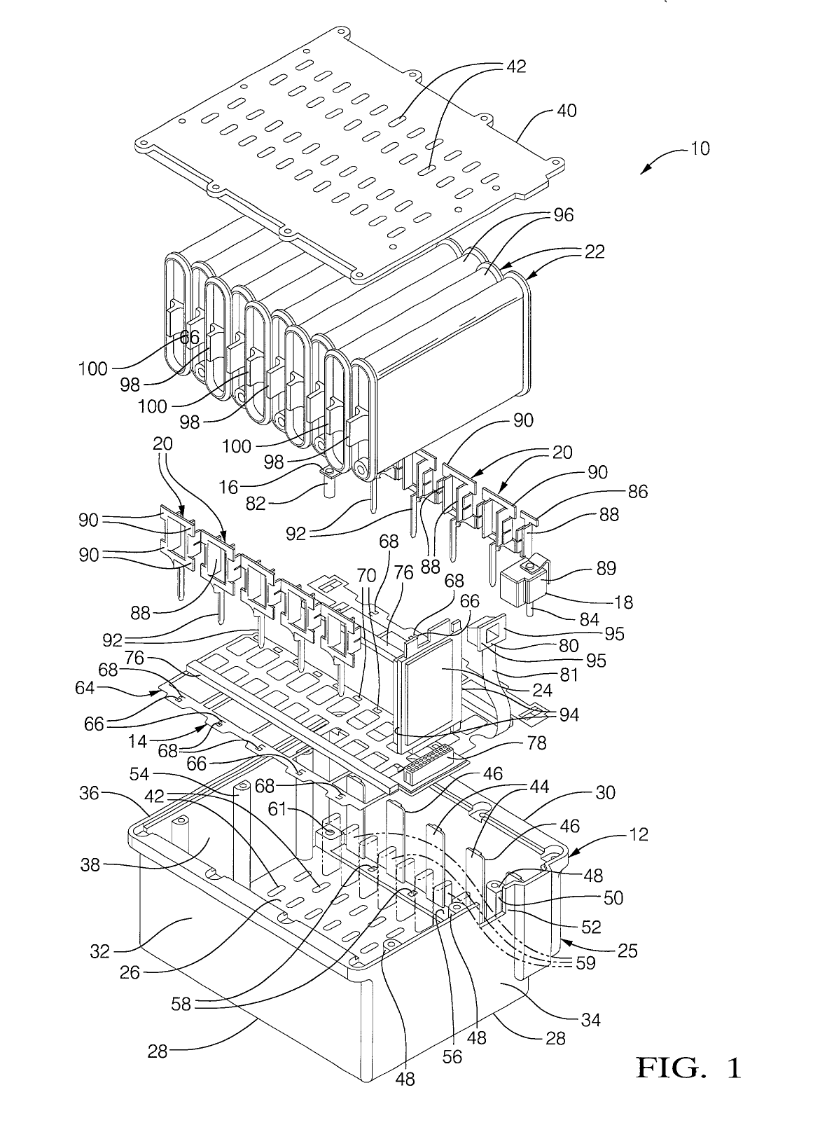

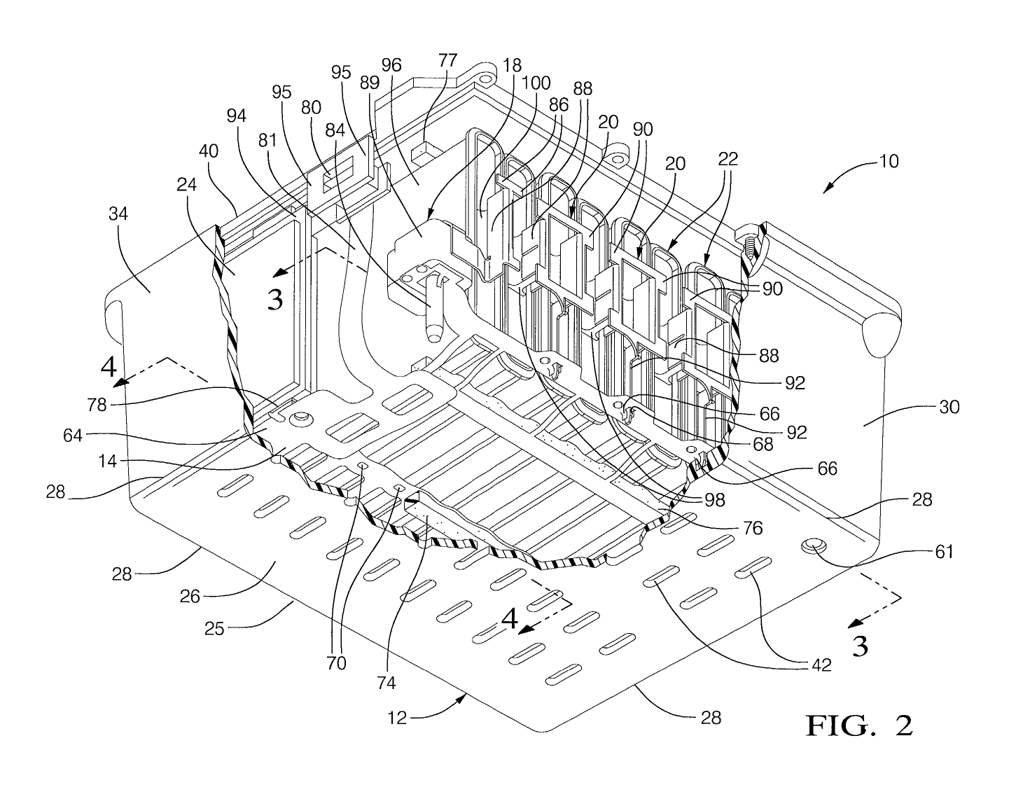

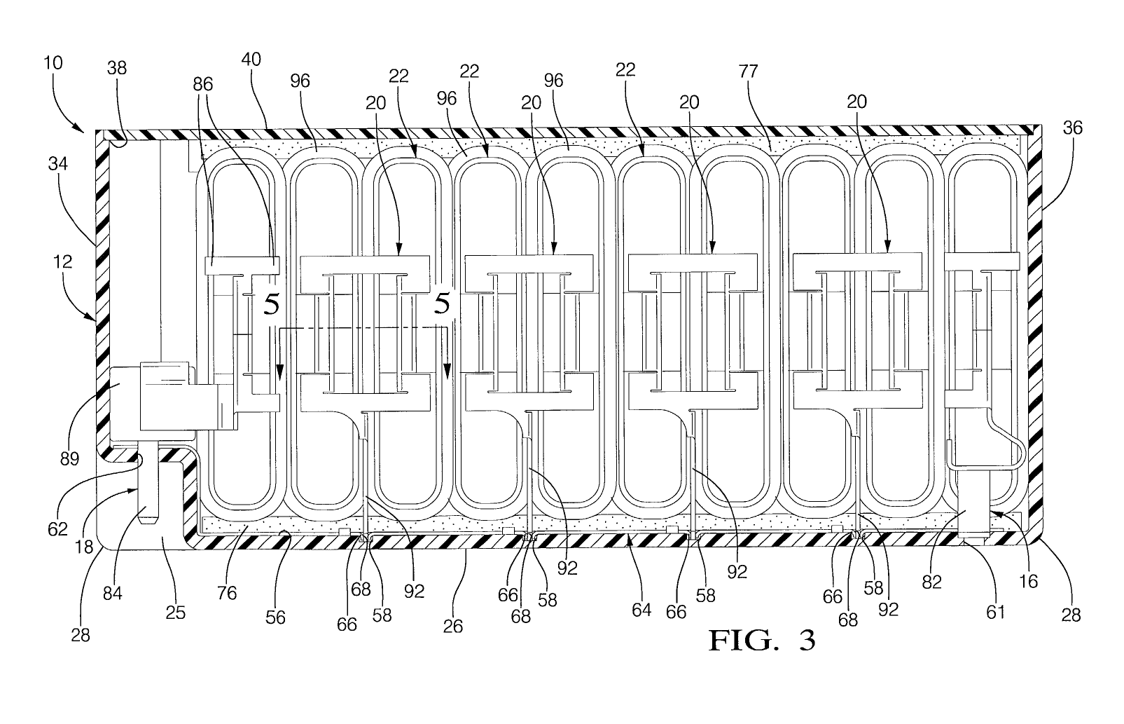

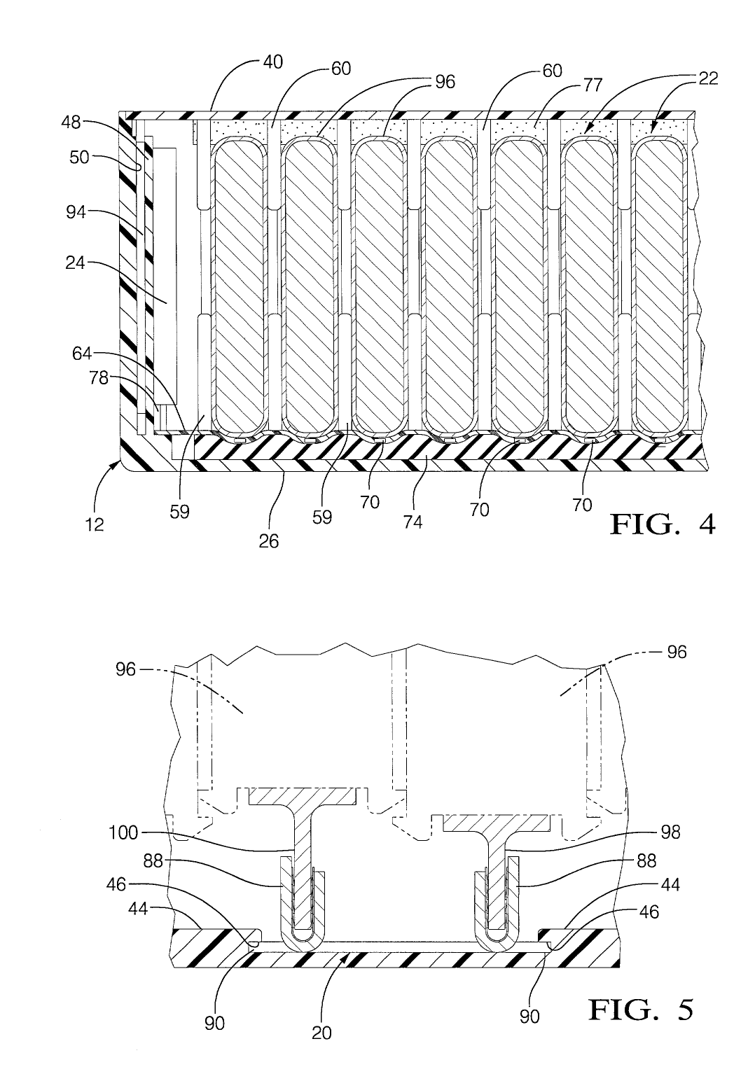

Internally, the side walls 30, 32 include guide ribs 44 defining vertical slots 46 for locating the buss bars 20 and terminals 16, 18. The front end wall 34 includes guide ribs 48 with vertical slots 50 for locating the ECM 24 and connector 80. A connector cutout 52 is also provided in an upper edge of the front end wall. The rear end wall 36 includes unslotted cover support ribs 54. The bottom wall 26 includes support pads 56 along both sides having guide recesses 58 spaced along the side walls 30, 32 between their ribs 44. Separators 59 (shown in phantom in FIG. 1) extend upward for spacing the batteries 22 apart. Similar separators 60, (FIG. 4) projecting down from the cover 40, may be provided to maintain separation of the batteries. Openings 61, 62 are also provided for the positive and negative terminals 16, 18.

The flexible circuit 14 has an insulating flexible sheet 64 on which is applied an integrated circuit with a plurality of conductors, not shown. The sheet 64 carries various spaced devices and features with open areas between to allow for the passage of cooling air within the case. Along outer edges, the sheet 64 provides longitudinally spaced contact openings formed by flexible flaps 66 coated with electrical contact material 68 connected with individual conductors, not shown, of the flexible circuit 14.

Centrally, sheet 64 carries a row of longitudinally spaced temperature sensors 70, also connected in the flexible circuit 14. A strip of resilient material 74, such as expanded foam, is carried beneath the sheet 64 under the sensors 70 to urge them upward. Additional resilient strips 76 are carried on an upper surface of the sheet 64 between the outer edges and the sensors 70 to resiliently support the batteries 22. Similar resilient strips 77 may also be provided beneath the cover 40 to hold the batteries firmly in their desired positions. An internal control connector 78 is provided on the sheet for connecting the circuit 14 to the ECM 24. An external control connector 80 is also connected at the end of an extended portion 81 of the circuit 14.

The positive and negative terminals 16, 18 are, respectively, female and male single post connectors 82, 84 for carrying the battery current to an external load. Both terminals are preassembled with buss bar portions having guide blades 86 that are received in vertical slots 46 at opposite ends of side wall 30 and include female blade connections 88 for connecting the post connectors 82, 84 with the batteries 22. The female post connector 82 is aligned by the slots 46 with the opening 61 in the case bottom wall 26. The male post connector 84 is aligned by the slots and extends through opening 62 of the bottom wall. A current sensor 89 is fitted on the male connector and remains above the bottom wall 26.

The buss bars 20 are also provided with guide blades 90 received in others of the vertical slots 46. The buss bars have dual female blade connections 88 connecting the ends of adjacent batteries 22 with one another. Prongs 92 extend downward to connect the buss bars with the contact material 68 on the flaps 66 of the flexible circuit 14. The electronic control module (ECM) 24 and the connector 80 also include guide blades 94, 95 receivable in the vertical slots 50 for positioning these components on the front end wall 34. There the ECM 24 plugs into the internal connector 78 of the flexible circuit and the external connector 80 may be connected with an external circuit through the cutout 52 in the front wall 34.

The batteries 22 in the illustrated battery pack 10 consist of ten lithium polymer units having cells enclosed by elongated and relatively flat metal shells or containers 96. Other numbers and forms of batteries and other materials for the containers may be used if desired. The ends of the containers are insulated and internally connected to carry electric current to positive and negative male blade terminals 98, 100, mounted on the container ends. The flat walls of the containers are spaced apart slightly to provide space for passing cooling air between the batteries for temperature control.

Assembly of the exemplary battery pack 10 is carried out in a simple and efficient manner made possible by the design of the various components described. The case 25 is positioned with the open top 38 facing vertically upward, although other orientations could be utilized if desired. The flexible circuit 14 is then placed in the case 25 with the sheet 64 on the bottom wall 26. The opening defining flaps 66 of the circuit are aligned with the guide recesses 58 of the bottom wall support pads 56 with the electrical contact material 68 facing upward. The resilient strips 76 also face upward as do the centrally positioned temperature sensors 70 and the internal connector 78. Resilient material 74 lies against the bottom wall underneath the central portion of the flexible sheet 64 to support the temperature sensors 70. The external connector 80 is fitted into slots 50 adjacent the connector cutout 52. The extended portion 81 of the flexible circuit extends downward along the front end wall 34 to the remainder of the circuit 14 lying on the bottom wall 26.

The buss bars 20, positive and negative terminals 16, 18 and ECM 24 may then be installed by passing them vertically downward so their guide blades 86, 90, 94 slide into their respective vertical slots 46, 50 in the case 25. The positive female post connector 82 is thus aligned with the cover opening 61 and the negative male post connector is guided into opening 62. The buss bars 20 are moved downward so that the prongs 92 extend into the guide recesses 58 of the case, forcing the flexible flaps 66 of sheet 64 down into the recesses. This assures positive contact of the prongs with the electrical contact material 68 on the flaps and connects the buss bars 20 with associated voltage carrying conductors of the flexible circuit 14. The ECM 24 is moved down to connect with the internal connector 78 of the flexible circuit 14 for sensing and adjusting voltage and current flow through the batteries of the pack 10.

The batteries 22 are then inserted (before or after the ECM) by moving them downward so that their respective blade terminals are fitted into the corresponding female blade connections 88 of the battery pack terminals 16, 18 and buss bars 20. Adjacent batteries 22 are slightly offset laterally in the case 25 to allow for compact fitting of enlarged ends of the containers 96 and are alternately reversed to connect opposite polarities to each of the buss bars 20. A series power circuit is thus provided through the batteries 22 from the post connector of the terminal 16 to the post connector of the terminal 18. If desired, the buss bars and batteries could be arranged to provide parallel or series parallel circuits within the scope of the invention. Upon installation, the battery containers 96 directly engage the temperature sensors 70 of the flexible circuit so that the temperature of each battery container may be monitored during operation.

Installation of the cover 40 on the case 25, whether by screws, adhesive or other means, encloses the components in the structural enclosure 12. The cover mounted separators 60 and the resilient strips 77 help maintain the batteries apart and urge the batteries down against the resilient strips 76 on the flexible sheet 64, thus providing a rattle free mounting. The lower strip of resilient material 74 is also compressed and urges the temperature sensors 70 continuously against the battery containers 96 to assure consistent heat transfer conditions and reliable temperature readings.

The use in the specification and claims of directional terms, such as bottom wall, side walls, front and rear end walls and open top, is not intended to limit the manner of use or assembly of the pack to any particular orientation. However, FIG. 1 does indicate a preferred, but not required, orientation for assembly wherein the open top of the case is facing upward during installation of the components.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A pack for storing and supplying electrical energy, said pack comprising:
a structural enclosure including a case having a bottom wall connected at peripheral edges with enclosing opposite side and end walls extending to an open top, and a cover mounted on the case and closing the top, the case having a plurality of guide recesses along the bottom wall adjacent at least one of the opposite side walls;
a flexible circuit in the enclosure and supported by the bottom wall, the circuit including spaced electrical connectors aligned with the guide recesses and a plurality of spaced thermal sensors resiliently supported above the bottom wall, the circuit being connectable with a control device;
a plurality of buss bars carried on said at least one of the opposite side walls and including prongs extending into said guide recesses and engaging the spaced electrical connectors for connecting the buss bars with the flexible circuit; and
a plurality of electrical energy storage devices having enclosing outer shells with closed opposite ends, and electrical terminals on at least one end, each terminal being connected with one of the buss bars to complete a power circuit through the storage devices, the resiliently supported thermal sensors each engaging the shell of one of the storage devices to sense the temperatures of the storage devices.

2. A pack as in claim 1 wherein there are guide recesses along the bottom wall adjacent the opposite side walls and said side walls each carry a plurality of buss bars.

3. A pack as in claim 1 wherein the flexible circuit, buss bars and storage devices are all installable in the case in a downward motion through the open top.

4. A pack as in claim 3 wherein the flexible circuit includes an insulating flexible sheet having conductors and said thermal sensors carried thereon, said conductors connected with at least one connector mounted to the sheet.

5. A pack as in claim 4 wherein the thermal sensors are supported by a resilient strip mounted on the flexible sheet below the sensors.

6. A pack as in claim 3 wherein the side walls of the case include ribs defining vertical slots receiving support blades of the buss bars for holding the buss bars on the side walls and aligning the prongs of the buss bars with their respective guide recesses and electrical connectors.

7. A pack as in claim 3 wherein the terminals of the storage devices have flat blade ends received in slot defining contacts of the buss bars.

8. A pack as in claim 3 and including a male terminal connected in the power circuit and projecting out of the enclosure through an opening in the case for external electrical connection.

9. A pack as in claim 8 and including a current sensor surrounding the male terminal within the enclosure for sensing current flow through the power circuit.

10. A pack as in claim 3 including an electronic control module mounted in the enclosure and connected with an internal connector in the flexible circuit.

11. A pack as in claim 10 wherein the module is mounted in slots on one of the walls of the case.

12. A pack as in claim 3 including an external connector in the flexible circuit, the external connector received in a slotted upper edge of one of the case walls and retained in position by the cover.

13. A pack as in claim 3 and having additional elements including an electronic control module connected with an internal connector of the flexible circuit, an external connector in the flexible circuit, male and female terminals and a current sensor, all also installable in the case through the open top in a downward motion which also completes internal electrical connections between said elements and the flexible circuit, buss bars and storage devices without the use of fasteners, tools or extra parts other than for retaining the cover on the case.

14. A pack as in claim 4 wherein the spaced electrical connectors of the flexible circuit include conductive material applied on flaps of the flexible sheet, the flaps being pressed into the guide recesses upon insertion of the buss bar prongs, thereby assuring electrical connection of the prongs with the conductive material.

15. A pack as in claim 1 wherein the bottom wall of the case and the cover both include multiple openings for passing air through the enclosure for cooling the storage devices.

16. A pack as in claim 1 wherein at least one of the case and cover include inwardly projecting separators for positioning and preventing contact of the batteries.

17. A pack as in claim 1 including means holding the storage devices firmly between the case and the cover.

18. A pack as in claim 1 wherein said electrical energy storage devices are batteries.

19. A pack as in claim 1 wherein said electrical energy storage devices are capacitors.
